(19) United States
(12) Patent Application Publication
(10) Pub. No.: US 2026/0311361 A1
(43) Pub. Date: Oct. 8, 2026

(54) TEMPORAL FEATURE SCALING FOR NEURAL NETWORK PROCESSING

(71) Applicant: Snap Inc., Santa Monica, CA (US)

(72) Inventors: Steven Roos, Eindhoven (NL); Zeqi Zhu, Eindhoven (NL); Orlando Miguel Pires dos Reis Moreira, Eindhoven (NL)

(21) Appl. No.: 19/172,104

(22) Filed: Apr. 7, 2025

(51) Int. Cl. G06T 7/73; G06T 19/00; G06V 10/82

(52) U.S. Cl. CPC G06T 7/73; G06T 19/006; G06V 10/82

(57) ABSTRACT

Systems, devices, and methods described herein relate to feature scaling for neural network processing. In some examples, temporal feature scaling is employed for efficient neural network processing. To process the neural network, a processing system accesses feature maps of a current input frame in a temporal sequence of input frames and scales the feature maps of the current input frame using excitation values generated from a previous input frame in the temporal sequence. The processing system generates new excitation values from the current input frame to perform scaling for a subsequent input frame in the temporal sequence.

### TECHNICAL FIELD

The subject matter disclosed herein relates to neural network processing. More specifically, but not exclusively, the subject matter relates to efficient feature map scaling techniques for neural networks that process temporal sequences.

### BACKGROUND

Neural networks employ various computational techniques to extract and process features from input data. The processing of sequential data through neural networks presents computational challenges, especially when dealing with real-time applications that benefit from speed and precision. Memory management and computational efficiency are ongoing considerations in neural network design and implementation, particularly for devices with limited resources, such as edge or mobile computing devices.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic illustration of a processing system, according to some examples.

FIG. 2 is a diagrammatic illustration of a squeeze-and-excitation (SE) architecture, according to some examples.

FIG. 3 diagrammatically illustrates feature map processing through multiple neural network layers, according to some examples.

FIG. 4 diagrammatically illustrates feature map processing using an SE mechanism, according to some examples.

FIG. 5 diagrammatically illustrates feature map processing using a modified SE mechanism, according to some examples.

FIG. 6 is a flowchart illustrating operations of a method for temporal feature scaling using a modified SE mechanism, according to some examples.

FIG. 7 is a graph illustrating accuracy measurements for neural networks employing temporal feature scaling, according to some examples.

FIG. 8 is a diagrammatic illustration of an extended reality (XR) device, according to some examples.

FIG. 9 is a block diagram illustrating components of a machine learning system, according to some examples.

FIG. 10 is a flowchart illustrating a machine learning pipeline, according to some examples.

FIG. 11 is a system architecture diagram showing a layered view of an artificial intelligence (AI) integrated system, according to some examples.

### DETAILED DESCRIPTION

Many neural networks, including various convolutional neural networks (CNNs), include a collection of interconnected layers, where each layer includes a set of feature maps. In this context, a feature map is, for example, a one-dimensional (1D) or two-dimensional (2D) array of values, similar to an input frame that is fed into the neural network. Feature maps represent intermediate results of an inference function. The value of a particular feature map element depends on values of feature map elements of one or more preceding layers of the neural network.

A “frame,” as used herein in the context of inputs to a neural network, includes a unit or set of data that represents a snapshot within a sequence of such units or sets. The snapshots can be captured or sampled over time. In the context of image processing, for example, a frame typically provides a single image or a portion of visual content from a video stream. For audio processing, a frame represents a segment of audio data, such as a time-sliced sample of a continuous audio signal. A frame can capture the state of an input signal at a specific point in time and can thus be used as the basis for sequential processing in temporal analysis. In some examples, frames are non-overlapping, where each frame is distinct and separate from the others, or overlapping, where frames share common data points with preceding or subsequent frames (e.g., to preserve continuity in the temporal domain). In the context of the present disclosure, “frames” (e.g., input frames of a neural network) include visual or auditory data and can also extend to other time-ordered sequences of data that a neural network processes.

In neural networks, channels often represent different aspects or features of the input data that are processed in parallel. Each channel captures a characteristic or transformation of the input. For example, in image processing, different channels can represent different color components or detected features associated with an input frame.

Squeeze-and-excitation (SE) is a mechanism that can be employed to improve a neural network by dynamic recalibration of feature weight on a channel-wise basis. For example, in a computer vision model, SE blocks can be introduced to improve vision task accuracy (e.g., in classification or detection tasks).

SE can improve a model's ability to capture important features by learning channel dependencies. An SE block can process channels by first “squeezing” each channel into a single scalar value through global average pooling, and then generating “excitation” values (e.g., coefficients) that determine how much to scale or weight each channel's contribution to the output. This channel-wise processing allows the model to adaptively emphasize or suppress different features based on their importance for current input. Once excitation values are available, a recalibration or scaling operation can be performed to re-weight original feature maps, for example, by multiplying each channel element-wise with its corresponding learned weight from the excitation operation. While initially developed for image processing, SE can be applied to other types of structured data.

While SE blocks can improve the overall accuracy or predictions of a model, they can also result in technical challenges related to latency and memory. Specifically, technical problems result from the application of a global pooling function to all feature maps for a current input frame (e.g., all feature maps resulting from an input convolution performed on the current input frame).

In a conventional SE block, scaling (e.g., recalibration) can only be performed after all feature maps are fully processed by a global pooling layer and the output of the global pooling layer is combined by two fully connected stages. In other words, the (excited) output feature maps can only be computed once their input feature maps have been fully “squeezed” and “excited.” This means that techniques allowing for parallel processing, such as by starting processing of a line of output once enough input is made available (before the entire input has been processed), may not be feasible with SE blocks. This causes increased latency in neural network processing.

Moreover, in a conventional SE block, the input feature maps are all buffered at the same time in memory, since the input feature maps have to be kept until all excitation values are computed so that the input feature maps can be transformed into (excited) output feature maps. This increases memory requirements, which can be particularly undesirable in resource-constrained environments, such as processors deployed in mobile or edge devices. For example, in mobile or edge devices where memory is a scarce resource, it may be desirable to buffer only a subset of input feature map lines instead of buffering entire input feature maps. However, the inclusion of conventional SE mechanisms may make this infeasible and put additional strain on memory resources.

Examples described herein provide an efficient SE mechanism for temporal sequences that addresses or alleviates technical limitations of pipeline parallelism and high buffer costs, particularly in the context of mobile or edge processing units. The present disclosure leverages the observation that within a temporal sequence, values of excitation coefficients are often highly correlated between subsequent frames. In some examples, a modified SE function uses excitation values from previous input frames to excite feature maps of a current input frame. This allows the computation of excitation values for a subsequent input frame to be performed in parallel with the computation of the excited feature maps for the current input frame.

The present disclosure describes methods, devices, and systems for processing temporal sequences of input frames through neural networks. In some examples, a method performed by one or more processors includes accessing feature maps of a current input frame in a temporal sequence and scaling these feature maps using excitation values that were generated from a previous input frame in the temporal sequence. While scaling the current frame's feature maps, new excitation values are generated from the current input frame to perform scaling for a subsequent input frame.

In some examples, scaling of the current frame's feature maps using the previous frame's excitation values can commence before any new excitation values are generated from the current frame. In some examples, feature maps are processed in a line-by-line manner.

The neural network includes an SE mechanism comprising one or more SE blocks that process output from convolution layers. In some implementations, the neural network includes multiple SE blocks arranged in cascade. When using such cascaded arrangements, each subsequent SE block uses excitation coefficients from progressively earlier frames in the temporal sequence for scaling operations associated with the current frame.

The previous input frame used for obtaining excitation values can be an immediately preceding frame in the temporal sequence, or in some examples, a frame prior to the immediately preceding frame. The processing can be performed by various types of processors, including (but not limited to) processors of mobile or edge devices. In some examples, a method of the present disclosure is performed by an event-based neural processor (e.g., a Neural Processing Unit (NPU)).

A system or unit of the present disclosure can be implemented in various computing devices, including XR devices equipped with sensors for capturing the temporal sequence of input frames. In some examples, the neural network is a part of a computer vision model, such as a computer vision model for generating object pose estimations from video frames. Techniques described herein are compatible with various neural network architectures, and can be implemented on dedicated hardware (e.g., accelerators) or using software-based approaches.

In a video processing context, the approach described leverages temporal relationships between video frames. Rather than waiting for the current frame's excitation values to be computed, a processing system uses excitation coefficients calculated from a previous frame to scale the current frame's feature maps. This modification enables immediate processing of output feature maps in parallel with computing new excitation values for subsequent frames.

As mentioned, techniques described herein can be applied for computationally efficient image processing (e.g., in machine learning applications such as object detection or object tracking) or audio processing (e.g., in machine learning applications such as command detection). While image processing and audio processing are example applications of the present disclosure, techniques described herein can be applied to other types of data. Furthermore, techniques described herein can be applied to various types of feature maps, and are not limited to feature maps of specific shapes or dimensions, or to a specific number or type of channels.

Various technical problems are addressed or alleviated by implementing techniques of the present disclosure. Firstly, the technical problem of synchronization bottlenecks relates to the manner in which global average pooling is performed in conventional SE implementations. Global average pooling is performed across all feature maps before generating excitation coefficients. This creates a hard synchronization point where the processing system must wait until all input values are available before computing the weights for output feature maps, preventing parallel processing and increasing computational latency. Examples described herein break the synchronization dependency by using excitation values computed from previous frames to scale current feature maps.

A further technical problem is created by the buffering of all input feature maps simultaneously in memory in traditional SE implementations. This imposes significant memory costs on certain processors, such as mobile or edge processors where memory is a scarce resource. Examples in the present disclosure enable more efficient handling of data (e.g., processing in a line-by-line manner), requiring reduced buffering of feature map lines in memory. By using previously computed excitation values, the system can process and output scaled feature map lines sequentially as input lines become available.

Furthermore, in some examples, a neural network includes multiple SE blocks arranged in cascade. By using excitation coefficients from progressively earlier frames in respective SE blocks, processing efficiencies can be maintained or improved.

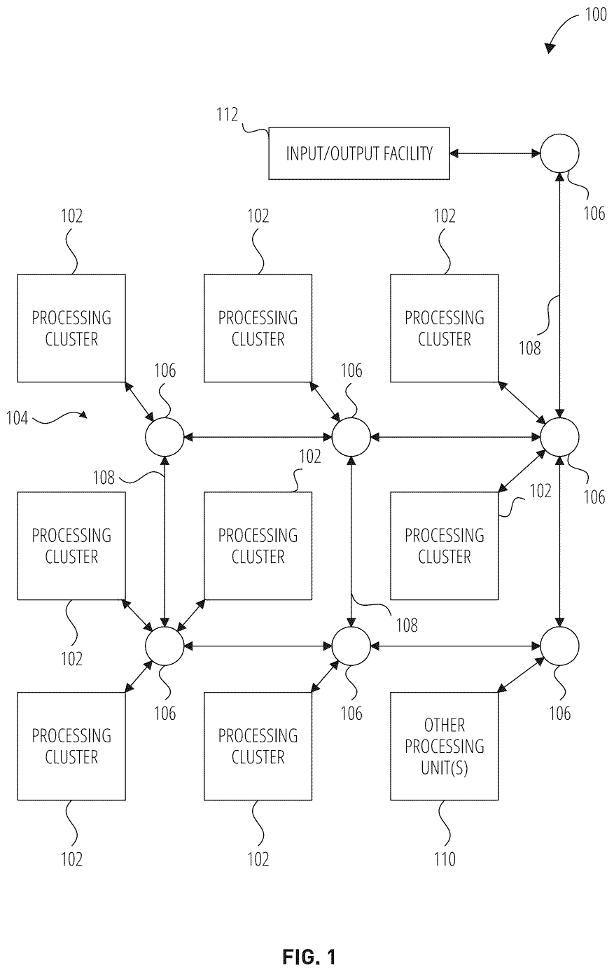

FIG. 1 illustrates a processing system 100 according to some examples. The processing system 100 is configured for event-based processing tasks. In some examples, the components of the processing system 100 are integrated into a single processing unit. For example, the processing system 100 may be implemented as an NPU in an Application-Specific Instruction Processor (ASIP) designed to facilitate inference on edge-of-cloud devices.

The processing system 100 includes a plurality of processing clusters 102, which are interconnected by a network 104. The network 104 functions as a message exchange network for exchange of messages, including event messages, instruction messages, configuration messages, or other messages, depending on the implementation. Messages may thus include instructions to perform computations, configuration instructions, or other data.

The network 104 includes nodes 106 forming an interface with respective processing clusters 102 and links 108 between the nodes 106. Processing units of one or more other types, such as one or more other processing unit(s) 110 as shown in FIG. 1, may also be included in the processing system 100 and coupled to the network 104. For example, the one or more other processing unit(s) 110 may include a digital signal processor, general purpose processor (e.g., a Central Processing Unit (CPU)), host processor, or Graphics Processing Unit (GPU).

In some examples, each processing cluster 102 has a message receiving facility to receive event messages via the network 104 and a message transmitting facility to transmit event messages via the network 104. Each of the processing clusters 102 may include one or more processing elements (not shown). Each processing element may be a neural processing element that, in the context of neural network processing, mimics the behavior of a biological neuron (at least to some extent), as is described further below.

Each of the processing clusters 102 may include its own local memory or cache, allowing for rapid data access. For example, a neuromorphic state memory may store values representative of a neuromorphic state associated with one or more processing elements. Processing elements may have their own respective memory storing their state or other information, or each processing cluster 102 may have a memory that stores state or other information for multiple processing elements.

In some examples, each processing cluster 102 has its own static random access memory (SRAM) (e.g., 256 kB of SRAM). Neuromorphic states may be calculated using, for example, FP32 (32-bit floating point) or FP16 (16-bit floating point).

The processing system 100 may further include an input/output facility 112 that is configured to receive input data and transmit output data. The input/output facility 112 may also selectively map messages. As a result, the processing clusters 102 may not only transmit messages directly, but may also have their messages indirectly redirected and broadcast via the input/output facility 112. For example, the input/output facility 112 can be configured to receive messages with message content and determine the destination of each respective message (e.g., using a mapping function and/or an element address and/or data values in the messages).

Different processing clusters 102 may be configured for different tasks. For example, some clusters may be dedicated to performing basic arithmetic computations, some clusters may be dedicated to neuromorphic computations, and other clusters may be dedicated to performing complex mathematical operations. In some examples, the processing clusters 102 are configured to perform neural network processing, while the one or more other processing unit(s) 110 perform other computational tasks. Alternatively or additionally, processing clusters may be provided that are capable of being reconfigured to perform one of various classes of operations. Likewise, a processing cluster may have a plurality of processing elements that may have the same functionality or different functionalities, or may be reconfigured to have a particular functionality.

Each processing element may be designed or configured to detect and generate event messages based on specific computational rules (e.g., spike when a threshold is exceeded). Neuromorphic states may be dynamically updated based on received event messages and computations performed within a processing cluster 102. In some examples, if the value of a neuromorphic state approaches or exceeds a threshold potential, the corresponding processing element can issue a control signal, prompting the message transmitting facility to send out one or more event messages (e.g., to other processing clusters 102 in the processing system 100).

The processing system 100 can be employed in various applications, such as image processing, audio processing, machine learning, pattern recognition, or real-time data analytics. For example, in an image processing application, the processing clusters 102 may be utilized to perform convolutional operations on image data and to process feature maps via SE layers as described in the present disclosure, while another processing unit (e.g., the other processing unit(s) 110) may handle tasks such as image rendering or video encoding.

The processing system 100 may efficiently handle layer-by-layer processing in a neural network context. The processing system 100 may utilize the processing elements in the processing clusters 102 to perform convolution operations that involve applying kernels, or filters, over input data (e.g., image data) to create feature maps. The processing elements may also apply other operations, such as activation functions and functions associated with SE mechanisms as described herein. In some examples, different layers of the neural network may be assigned to different subsets of the processing clusters 102 for efficient execution.

Deep neural networks (e.g., CNNs) comprise a plurality of neural network layers. Each neural network layer typically includes a plurality of neural network computation elements. Neural network computation elements in a layer may receive weighted inputs from neural network computation elements in a preceding layer or an input device and in turn may have outputs to neural network computation elements in a succeeding layer. The specific way in which a neural network layer is connected to a preceding layer depends on its type. By way of example, in a fully-connected layer, each neural network computation element may receive an input from a neural network computation element in a preceding layer. In a convolutional layer, each neural network computation element may receive an input from a neural network computation element of a preceding layer that is within the range of a convolution kernel centered around a local address corresponding to a local address in the convolutional layer. A pooling layer is used for a spatial dimension reduction. Respective neural network computation elements of a pooling layer correspond to respective sets of neural network computation elements in the preceding layer. A pooling operation for a respective neural network element of a pooling layer, for example, involves selecting a value from its respective set of neural network elements in the preceding layer, such as sampling a maximum value, a minimum value, a median value, or a value of a specific one of the respective set of neural network elements. Alternatively, the pooling operation involves computing the average value from the respective set of neural network elements in the preceding layer.

An event-based or message-based processing system, such as the processing system 100, can be configured as a deep neural network. In such cases, at least some of the processing elements of the processing clusters 102 are configured as neural network computation elements that may function as described above. In some examples, the processing elements may be provided as dedicated hardware that function as neural network computation elements. In other examples, this can be achieved by configuring the processing system 100 such that the processing elements are programmable to function as neural network computation elements. In some examples, each processing element has a dedicated processor, while in other examples, the processing elements of a processing cluster 102 share a processor. In operation, the processing elements of the processing clusters 102 may thus, when configured or functioning as neural network elements, receive input messages and transmit output messages via the network 104.

In some examples, each processing cluster 102 functions as a neuron core. Each processor cluster 102 may be configured to operate using single instruction, multiple data (SIMD) processing. For example, each processing cluster 102 may be configured to perform a single instruction on four data inputs in parallel.

In some examples, since each processing cluster 102 has its own processing capabilities and memory, it is possible to scale the neuron capacity of the processing system 100 to create a mesh network-on-chip (NOC) of neuron cores of a desired size, capacity, or performance.

When processing a neural network, in some examples, the processing system 100 implements event-based processing. For example, a neuron activation is only propagated through the network 104 if its value constitutes an “event” (e.g., a value is non-zero or exceeds a threshold value). The processing system 100 therefore exploits sparsity by, for example, only considering certain values as “events.” Since only active neurons transmit data, when compared to a conventional architecture that may process all neuron values, this reduces the volume of data that needs to be processed and transferred, enhancing efficiency.

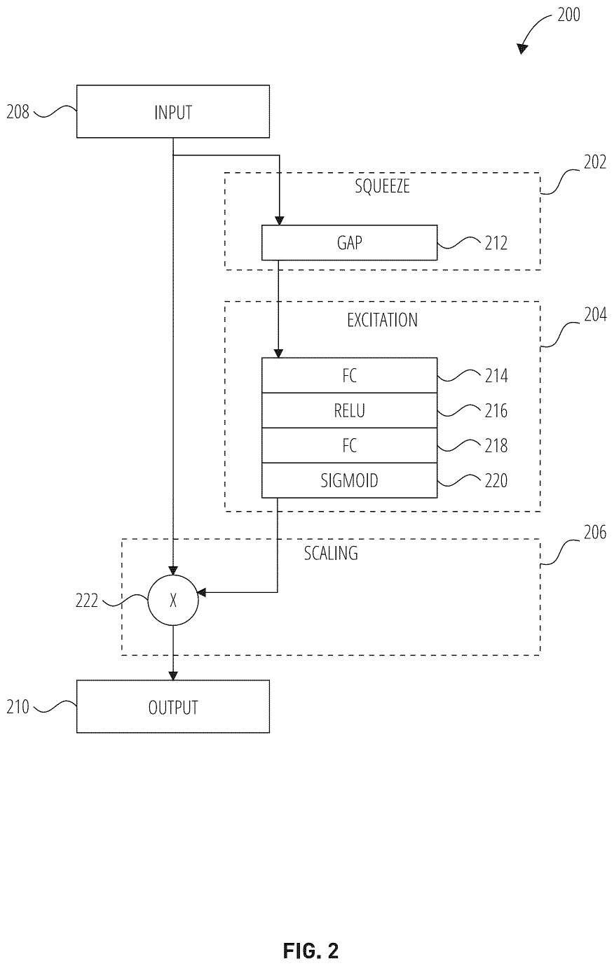

FIG. 2 is a diagrammatic illustration of an SE architecture 200, according to some examples. The SE architecture 200 is shown to include a squeeze component 202, an excitation component 204, and a scaling component 206, used to process input 208 to generate output 210. The input 208 comprises, for example, feature maps received from one or more convolution layers in the relevant neural network.

The SE architecture 200 is employed to improve feature selection by adaptively recalibrating channel-wise feature responses. For example, the SE architecture 200 operates on a feature map tensor with the shape (B, H, W, C), where B is the batch size, H and W are the spatial dimensions (height and width), and C is the number of channels. The goal of the SE architecture 200 is to emphasize important feature maps while suppressing less useful ones, thereby improving the network's representational power.

The squeeze component 202 condenses the spatial information of each channel into a single value. For example, this is done by applying global average pooling as indicated by global average pooling layer 212 in FIG. 2, which computes the average activation of each channel across all spatial locations. For the feature map tensor shape above, the result is a (B, 1, 1, C) tensor, meaning that for each sample in the batch, the squeeze component 202 provides a single scalar value per channel, summarizing its overall activation. This step captures the global context of each feature map, helping the network understand which channels carry the most important information.

Through the training of the excitation component 204, the network learns how to weight each channel dynamically. In FIG. 2, the excitation component 204 is shown to include a fully connected layer 214, a ReLU function 216 (rectified linear unit function, which is an example activation function), a fully connected layer 218, and a sigmoid function 220 (also an example activation function). The fully connected layer 214 operates on the input data first by reducing the number of channels to a smaller dimension, introducing a bottleneck to capture cross-channel dependencies efficiently. The ReLU function 216 then introduces non-linearity. The fully connected layer 218 then restores the tensor back to its original number of channels (C), and the sigmoid function 220 is an activation function applied to ensure the output values are between 0 and 1. This process generates a set of weights that indicate the importance of each channel.

The scaling component 206 performs a scaling step, or recalibration step. This step takes the original input feature map (e.g., (B, H, W, C)) and scales it by multiplying each channel element-wise with its corresponding learned weight from the excitation step (see scaling operation 222 in FIG. 2). Since these weights are in the range of 0 to 1, channels that are deemed important receive a higher weight, while less informative channels are suppressed. This allows the network to adaptively focus on the most relevant features at each layer, improving its ability to distinguish meaningful patterns.

After the SE operations are performed on the input 208, the output 210 maintains the same shape as the input 208 (e.g., (B, H, W, C)) but with recalibrated channel activations. Accordingly, in some examples, input feature maps (e.g., the output from an input convolutional layer that feeds into the squeeze component 202) are processed to yield output feature maps with the same dimensions, but weighted/scaled using excitation coefficients. The SE architecture 200 may be implemented as part of a larger neural network system, with multiple SE blocks potentially arranged in cascade.

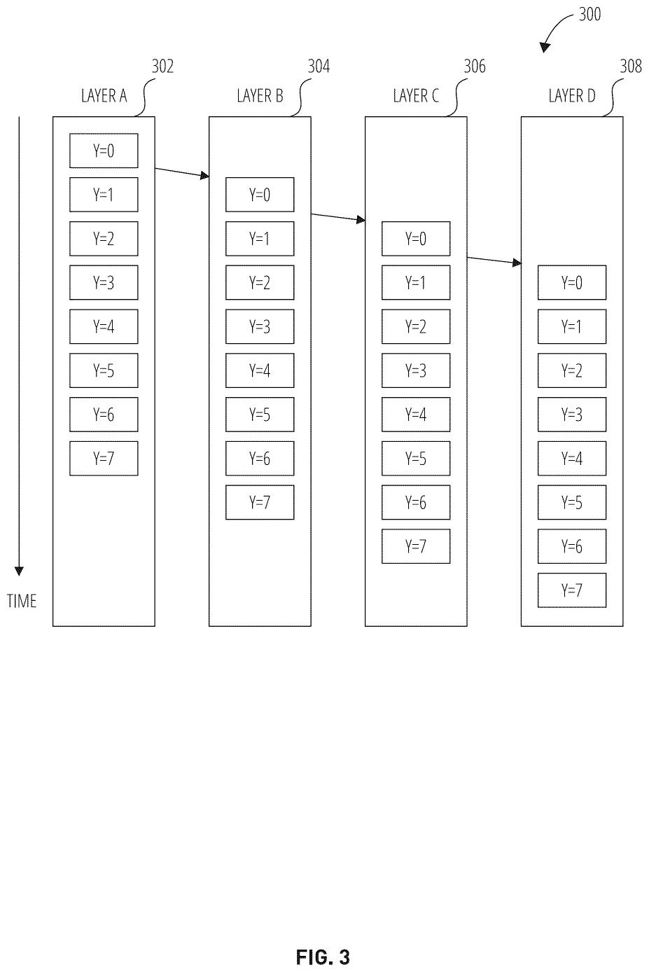

FIG. 3 is a timing diagram 300 illustrating feature map processing through multiple neural network layers, according to some examples. FIG. 3 depicts four layers of an example neural network: layer A 302, layer B 304, layer C 306, and layer D 308. Each layer processes feature map lines labeled Y=0 through Y=7 in sequence, as depicted in FIG. 3 along a time axis. The vertical arrangement of the feature map lines represents their temporal processing order.

Various conventional network layers, such as those shown in FIG. 3, can be processed in a pipelined fashion. This means that the next layer (e.g., layer B 304) may start processing a line (e.g., Y=0) when the previous layer (e.g., layer A 302) is done with it. In other words, the neural network can process data in a line-by-line manner where the next layer starts processing as soon as the previous layer completes a line.

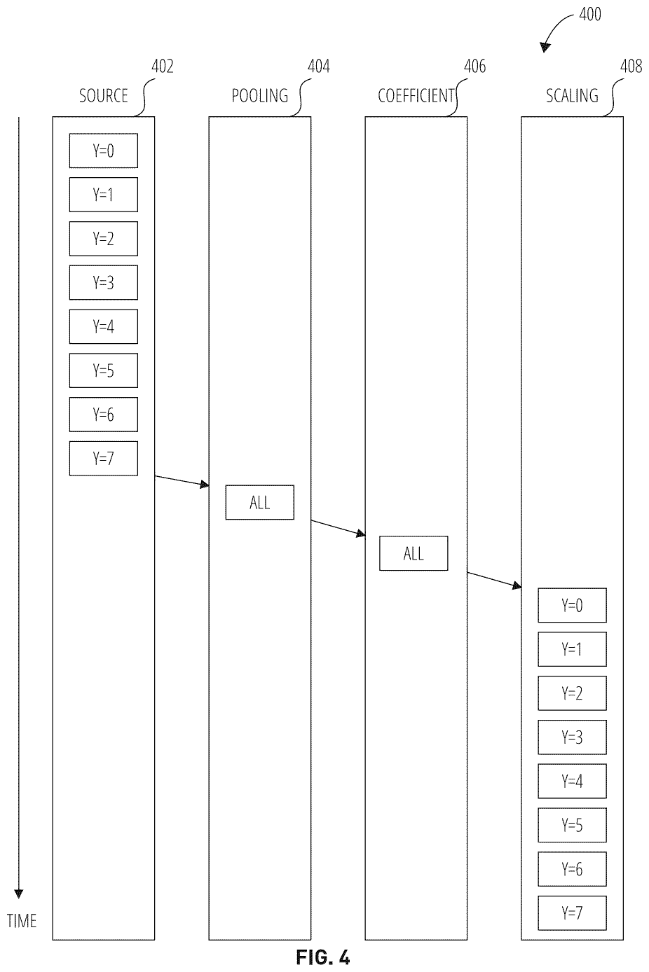

While various conventional neural network layers can pipeline their operations, a conventional SE mechanism faces a hard synchronization barrier where a scaling component, such as the scaling component 206 of FIG. 2, must wait for all input data before proceeding with scaling operations. This technical problem is illustrated in FIG. 4, which shows a timing diagram 400 for feature map processing using an SE mechanism.

FIG. 4 depicts four layers: a source layer 402, pooling layer 404, coefficient layer 406, and a scaling layer 408. In some examples, and with reference to FIG. 2, the source layer 402 corresponds to a layer, such as a convolution layer, that provides the input 208 of FIG. 2, while the pooling layer 404, coefficient layer 406, and scaling layer 408, correspond respectively to the squeeze component 202, excitation component 204, and scaling component 206 of FIG. 2.

The source layer 402 shows sequential feature map lines labeled Y=0 through Y=7, representing input data processed in a line-by-line manner. For example, the input data can be feature map lines for the feature maps of a current input frame (e.g., multiple channels associated with the current input frame) in a temporal sequence of input data. In the pooling layer 404, sequential feature map lines for each feature map are combined through a global average pooling operation, indicated by the “ALL” designation.

The coefficient layer 406 receives the pooled data, also marked as “ALL,” indicating that excitation coefficients for the current input frame are generated only after the complete pooling operation is finished for the current input frame. This represents the traditional approach. The scaling layer 408 shows how the generated coefficients are applied to scale individual feature map lines Y=0 through Y=7. In conventional implementations, this scaling cannot begin until all coefficients are computed from the current input frame, creating a processing dependency that impacts computational efficiency.

As shown in FIG. 4, an SE mechanism can thus incur a longer latency because the pooling layer 404 depends on all lines of its input and the scaling layer 408 waits until the coefficients (e.g., excitation values) have been computed by the coefficient layer 406 after the operations of the pooling layer 404.

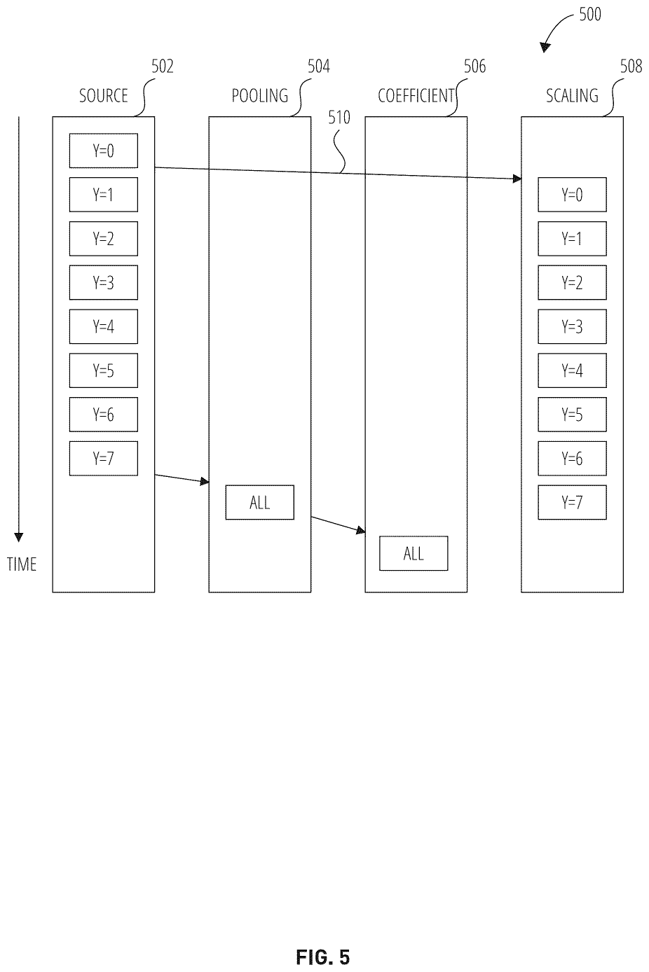

FIG. 5 diagrammatically illustrates feature map processing using a modified SE mechanism, according to some examples. A timing diagram 500 is shown in FIG. 5 to illustrate how the modified SE mechanism addresses the technical problem depicted in FIG. 4.

FIG. 5 depicts four layers: a source layer 502, pooling layer 504, coefficient layer 506, and a scaling layer 508. The layers themselves are similar to those shown and described with reference to FIG. 2 and/or FIG. 4. However, the modified SE mechanism differs significantly in that, when processing a current input frame, it relies on excitation values from a previous input frame for more efficient parallel processing while maintaining accuracy.

The connection 510 between the source layer 502 and scaling layer 508 as shown in FIG. 5 illustrates how the scaling layer 508 starts processing feature map lines immediately upon receipt. The scaling layer 508 can immediately start processing feature map lines since excitation values are already available. In order to do so, the scaling layer 508 uses the excitation coefficients that were already computed by the coefficient layer 506 for a previous input frame as opposed to waiting for the excitation coefficients for the current input frame to be computed by the coefficient layer 506.

In this context, the “previous” input frame can be the immediately preceding input frame or an even earlier frame in the temporal sequence. In other words, a processing system can implement various “delayed attention frame” settings. The term “delayed attention frames” refers to the number of frames in a temporal sequence by which the excitation values are delayed relative to the current frame being processed. For instance, the delayed attention frames setting can be set at 1 (immediately preceding frame), 2, 3, 4, 5, or 10.

In the modified approach shown in FIG. 5, the pooling layer 504 and the coefficient layer 506 still operate to process the input data for the current input frame to compute the excitation values for the current input frame. However, in the modified SE mechanism, the excitation values for the current input frame are not used to excite the output feature maps for the current input frame, but rather to excite feature maps associate with a subsequent input frame in the temporal sequence, thereby continuing to obviate the aforementioned synchronization barrier and allow for more efficient parallel processing.

Moreover, FIG. 5 depicts how memory buffering requirements can be reduced by using the modified SE mechanism. In a conventional approach, a processing system may buffer all input feature maps associated with a current input frame while waiting for global average pooling to be completed and keep buffering them while waiting for excitation coefficient computation, and then scale them once these operations have been completed. When using the modified SE mechanism, the processing system can buffer the input feature maps for global average pooling purposes but need not buffer them while waiting for the excitation coefficient computation.

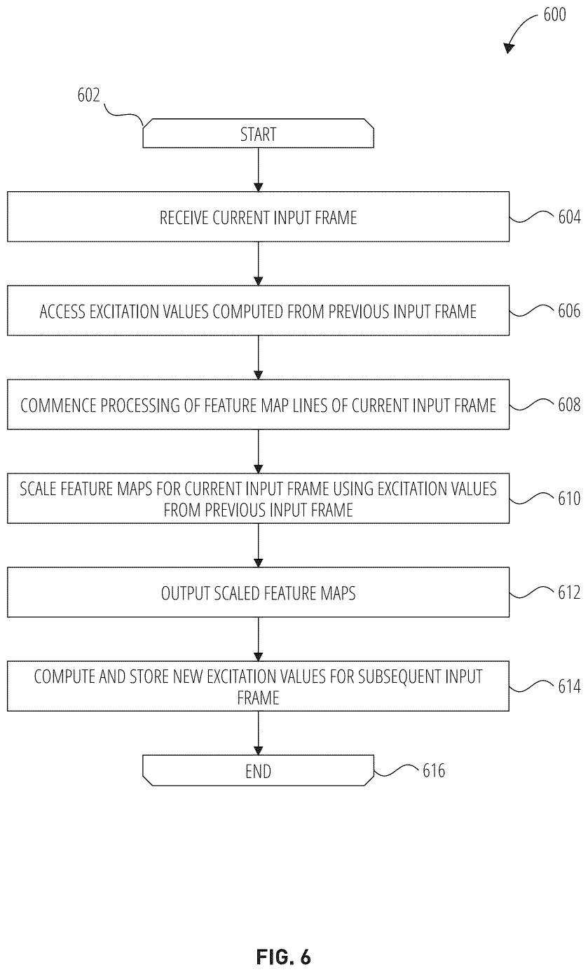

FIG. 6 illustrates a method 600 for temporal feature scaling using a modified SE mechanism, according to some examples. In some examples, the modified SE mechanism is the mechanism as described with reference to FIG. 5.

The method 600 can be performed by various types of computing devices. By way of example and not limitation, aspects of the method 600 may be performed by a computing device equipped with the processing system 100 of FIG. 1, or components thereof. Accordingly, the processing system 100 is used as an example in the description of FIG. 6 below. However, the processing system 100 is a non-limiting example of a system that can perform the method 600, and it will be appreciated that the method 600 may also be performed using one or more other systems, processors, or devices.

The computing device performing the method 600 can, for example, be a personal computing device, a server, a shared computing node, or a mobile or edge device, such as an XR device. The computing device uses the processing system 100 to process consecutive input frames through a neural network. For example, in the case of video processing, the neural network may be used for object detection or object tracking. The neural network may, for example, be a CNN that includes one or more SE blocks.

The method 600 starts at opening loop element 602, and proceeds to operation 604, where the processing system 100 receives a current input frame in sequence of input frames. For example, the current input frame comprises image data that is part of a video stream captured by a camera of an XR device or other imaging system.

At operation 606, the processing system 100 accesses excitation values that were previously computed from a prior input frame in the sequence. For example, a squeeze component 202 and an excitation component 204 as described with reference to FIG. 2 are used to generate excitation values from feature maps of the prior input frame. These excitation values are stored in memory or registers from processing the previous frame.

At operation 608, processing system 100 commences processing of feature map lines from the current input frame. For example, feature maps are received, at an SE section, as the output of one or more prior convolution layers in the relevant neural network, and are processed sequentially in a line-by-line manner. At operation 610, the processing system 100 scales the feature maps to produce (excited) output feature maps using the excitation values accessed from the previous frame. This scaling can begin before all feature map lines are received, enabling parallel processing. This scaling can also commence before, or while, the SE mechanism performs global average pool and generates the (new) excitation values from the specific data of the current input frame.

The processing system 100 outputs the scaled feature maps at operation 612. For example, the processing system 100 outputs the scaled feature map for processing by a next neural network layer or model component. In this context, the scaled feature maps can be processed immediately by subsequent layers without waiting for the excitation coefficients to be computed for the current frame, since it uses the excitation coefficients from the previous frame. This allows for more efficient pipelined processing where each layer can begin working as soon as it receives input from the previous layer.

At operation 614, the processing system 100 generates the new excitation values for use with respect to a subsequent input frame in the same manner. As mentioned, the new excitation values can be computed by the processing system 100 while scaling the current feature maps. The method 600 concludes at closing loop element 616.

It will be appreciated that the method 600 is repeated for subsequent frames in the temporal sequence, with each iteration using excitation values from a previous frame for scaling. It is noted that, where previous excitation values are not available, such as when processing a first or second frame, the processing system 100 can fall back on conventional SE processing as described with reference to FIG. 4. In implementations with multiple SE blocks arranged in cascade, each subsequent block utilizes excitation coefficients from progressively earlier frames in the sequence, in some examples. The temporal relationship between frames allows maintaining accuracy while enabling efficient parallel processing.

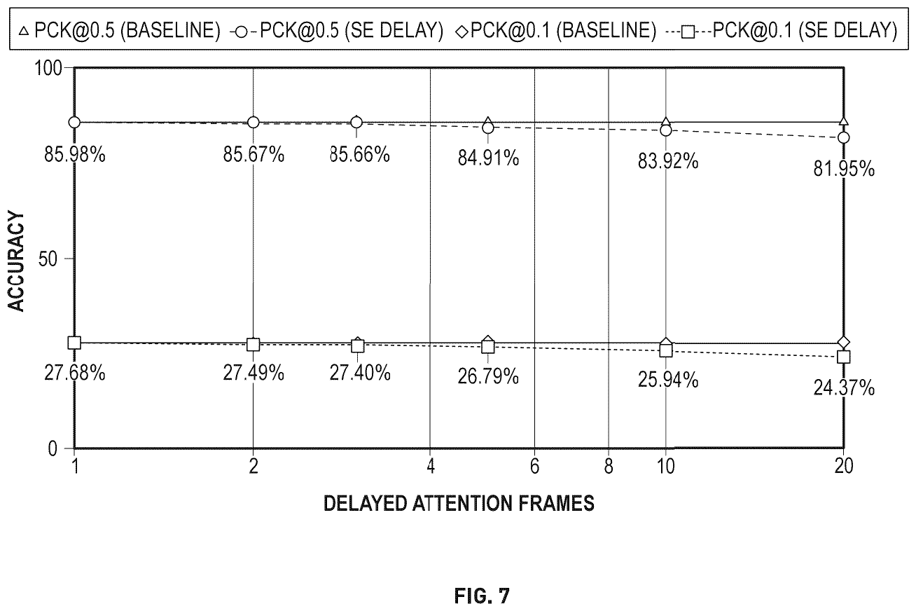

Testing demonstrates that the modified SE approach of the present disclosure can maintain accuracy while enabling more efficient processing. FIG. 7 illustrates accuracy measurements for neural networks employing temporal feature scaling, according to some examples.

The graph presents experimental results evaluating a “Simple Baseline” model as described in “Simple Baselines for Human Pose Estimation and Tracking” by Xiao, Wu, and Wei, published in the European Conference on Computer Vision (ECCV), 2018, with an “EfficientNetB0 ” backbone for human body pose estimation, on the “MPII Human Pose” benchmark as described in “2D Human Pose Estimation: New Benchmark and State of the Art Analysis” by Andriluka, Pishchulin, Gehler, and Schiele, published in the IEEE Conference on Computer Vision and Pattern Recognition (CVPR), 2014.

Referring firstly to the “Simple Baselines” model, the model presents an effective approach for 2D human pose estimation. The model adds a small number of deconvolutional layers on top of a backbone to produce heatmaps for keypoints. Using three deconvolutional layers with batch normalization and ReLU activation, the model refines low-resolution feature maps into detailed heatmaps, which are then processed using a mean squared error loss function to match ground-truth keypoints. EfficientNet-B0 is a CNN architecture that serves as the foundational model in the EfficientNet family. It employs a compound scaling method to uniformly scale network depth, width, and resolution, achieving a balance between efficiency and performance. The architecture is built upon inverted bottleneck residual blocks, similar to those in MobileNetV2, and incorporates SE blocks to enhance feature representation. The SE blocks adaptively recalibrate channel-wise feature responses, allowing the network to focus on the most informative features. During operation, the backbone network (EfficientNetB0) extracts deep image features, which are then processed through a series of deconvolutional layers to generate high-resolution feature maps.

During testing, the SE mechanism was modified to employ delayed attention frames as shown in FIG. 7, and as described with reference to FIG. 5 and FIG. 6. An input size of 256×256 was selected on the validation set of MPII, using the PCK (Percentage of Correct Keypoints) metric with detection thresholds of 0.5 and 0.1. FIG. 7 shows the results for the modified SE mechanism (marked “SE Delay”) against the baseline (with no delayed attention frames).

Accuracy remains relatively stable for delays of up to four frames, with PCK@0.5 showing only minimal degradation from 85.98% to 84.91%, and PCK@0.1 also showing minimal degradation from 27.68% to 26.79%. The experimental results indicate that, up to about three or four frames, the loss is negligible or near negligible, while loss is still not severe even up to 10 frames.

Overall, this demonstrates that using excitation coefficients from previous frames can have minimal impact on accuracy up to four or even more frames of delay, with more substantial degradation only occurring at longer delays. The results validate the approach of using previous frame coefficients to enable more efficient processing while maintaining model performance, and confirm the insight that excitation coefficients can often remain highly correlated across several consecutive frames in a temporal sequence.

As discussed, example techniques described herein can be implemented by a computing device. The computing device includes a processing system as discussed above. In some examples, the computing device is an XR device, such as an augmented reality (AR) or virtual reality (VR) device, that includes the processing system as discussed above. An XR device can include an optical device communicatively coupled to the processing system. The XR device can be configured to capture image frames using the optical device and process, using the processing system, the image frames as described herein. The XR device can include an audio capture device, such as a microphone, communicatively coupled to the processing system. The XR device can be configured to capture audio signals using the audio capture device and process, using the processing system, frames of an audio signal as described herein. The XR device can apply techniques described herein for more efficient processing of a neural network.

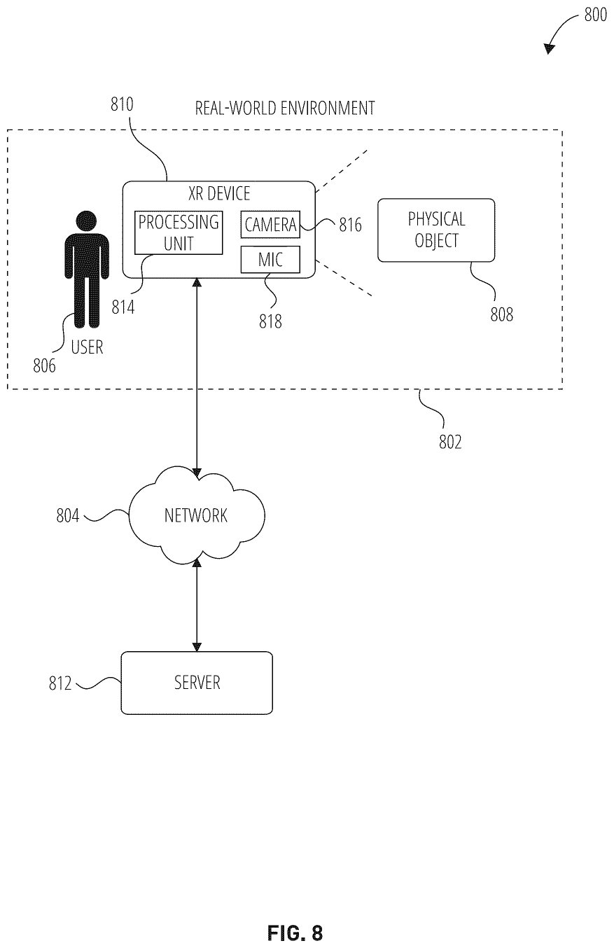

Referring now to FIG. 8, a diagram is shown to illustrate a network environment 800 suitable for operating an XR device 810, according to some examples. The network environment 800 includes an XR device 810 and a server 812, communicatively coupled to each other via a network 804. The server 812 may be part of a network-based system. For example, the network-based system may be or include a cloud-based server system that provides additional information, such as virtual content (e.g., three-dimensional models of virtual objects, or augmentations to be applied as virtual overlays onto images depicting real-world scenes) to the XR device 810.

The term “XR” refers to “extended reality,” which covers augmented reality (AR) and/or virtual reality (VR). The term “AR” refers to an interactive experience of a real-world environment where physical objects or environments that reside in the real world are “augmented” or enhanced by computer-generated digital content (also referred to as virtual content or synthetic content). An AR device can enable a user to observe a real-world scene while simultaneously seeing virtual content that may be aligned to objects, images, or environments in the field of view of the AR device. AR can also refer to a system that enables a combination of real and virtual worlds, real-time interaction, and three-dimensional (3D) representation of virtual and real objects. A user of an AR system can perceive virtual content that appears to be attached or interacting with a real-world physical object, e.g., overlaid on the real world.

The term “VR” refers to a simulation experience of a virtual world environment that is distinct from the real-world environment. Computer-generated digital content is displayed in the virtual world environment. A VR device may block out the field of view of the user with virtual content that is displayed based on a position and orientation of the VR device. VR also refers to a system that enables a user of a VR system to be completely immersed in the virtual world environment and to interact with virtual objects presented in the virtual world environment. In general, AR and VR devices are referred to as XR devices. A further device is based on mixed reality “MR” which typically represents a hybrid of AR and VR, in which world facing cameras acquire images that are merged with virtual content to be displayed on a VR device. An AR device is generally transparent or see through, while VR and MR devices are opaque or non-see through. The term “XR” may thus also refer to MR.

Referring again to FIG. 8, a user 806 operates the XR device 810. The user 806 may be a human user (e.g., a human being), a machine user (e.g., a computer configured by a software program to interact with the XR device 810), or any suitable combination thereof (e.g., a human assisted by a machine or a machine supervised by a human). The user 806 is not part of the network environment 800 but is associated with the XR device 810.

The XR device 810 may be a computing device with a display such as a smartphone, a tablet computer, or a wearable computing device (e.g., watch or glasses). The computing device may be hand-held or may be removably mounted to a head of the user 806. The XR device 810 includes various components, including a processing unit 814 and a camera 816. In some examples, the display may be a screen that displays what is captured with the camera 816 of the XR device 810. In other examples, the display of the device may be transparent or semi-transparent such as in lenses of wearable computing glasses. In other examples, the display may be a transparent display such as a windshield of a car, plane, or truck (e.g., as part of a heads-up display system). In another example, the display may be non-transparent and wearable by the user to cover the field of vision of the user.

The user 806 operates an application of the XR device 810. The application may include an AR application configured to provide the user 806 with an experience triggered or enhanced by a physical object 808, such as a two-dimensional physical object (e.g., a picture or navigation prompt), a three-dimensional physical object (e.g., a statue), a location (e.g., a factory), or references (e.g., perceived corners of walls or furniture, or Quick Response (QR) codes) in the real-world environment 802. For example, the user 806 may point the camera 816 of the XR device 810 to capture an image of the physical object 808 and a virtual overlay may be presented over the physical object 808 via the display. Certain experiences may also be triggered, enhanced, or controlled by a hand of the user 806. Accordingly, it will be appreciated that the physical object 808 or real-world object being tracked or detected by the XR device 810 may be the hand of the user 806.

To allow the user 806 to have an AR experience and/or interact with virtual objects, the XR device 810 may detect the positions and movements of objects, including, for example, one or both hands of the user 806. The XR device 810 may use hand positions, shapes, or movements to determine the user's intentions in manipulating virtual objects. To this end, the XR device 810 includes tracking components implemented using the processing unit 814. The tracking components may track the pose (e.g., position and orientation) of the XR device 810 relative to the real-world environment 802 using image sensors (e.g., the camera 816 and/or other image sensors), inertial sensors (e.g., a gyroscope, accelerometer, or the like), wireless sensors (e.g., Bluetooth™ or Wi-Fi sensors), a Global Positioning System (GPS) sensor, and/or an audio sensor (e.g., the microphone 818 shown in FIG. 4).

The processing unit 814 may be used to generate tracking estimates or predictions, e.g., to predict the location or pose of a tracked object. The XR device 810 may utilize one or more object tracking machine learning models or one or more object detection machine learning models for this purpose. A specific, non-limiting example of a machine learning model is a trained neural network for gesture recognition.

In this context, a machine learning model may comprise a neural network trained on suitable training data to identify and/or track objects in one or more frames captured by the XR device 810. As mentioned, in some examples, the components of the processing system 100 of FIG. 1 are integrated into a single processing unit. The processing unit 814 of the XR device 810 may comprise an event-driven processing system, such as the processing system 100. Accordingly, the XR device 810 is a (non-limiting) example of a computing device in which the processing system 100 can be implemented. The processing system 100 may, for example, facilitate real-time processing of sensor data captured by the XR device 810, such as image data captured using the camera 816 or audio data captured using the microphone 818.

The processing unit 814 may execute operations described herein to for more efficient neural network processing. This may also result in improved battery life, reduced memory resource requirements, or lower latency. The XR device 810 may, for example, apply such techniques in the processing of image data or audio data (e.g., to process and update feature maps that represent image features or to process and update feature maps that represent sound features).

In some examples, the server 812 may be used to perform certain detection and tracking based on sensor data (e.g., image and depth data) from the XR device 810. Accordingly, the XR device 810 or the server 812, or both, can perform image processing, object detection and/or object tracking functions based on images captured by the XR device 810 and one or more parameters internal or external to the XR device 810. Accordingly, the server 812 may also, in some examples, benefit from employing techniques described herein. In some examples, the server 812 may include or be coupled to a processing system such as the processing system 100 of FIG. 1.

The network 804 may be any network that enables communication between or among machines (e.g., server 812), databases, and devices (e.g., XR device 810). Accordingly, the network 804 may be a wired network, a wireless network (e.g., a mobile or cellular network), or any suitable combination thereof. The network 804 may include one or more portions that constitute a private network, a public network (e.g., the Internet), or any suitable combination thereof.

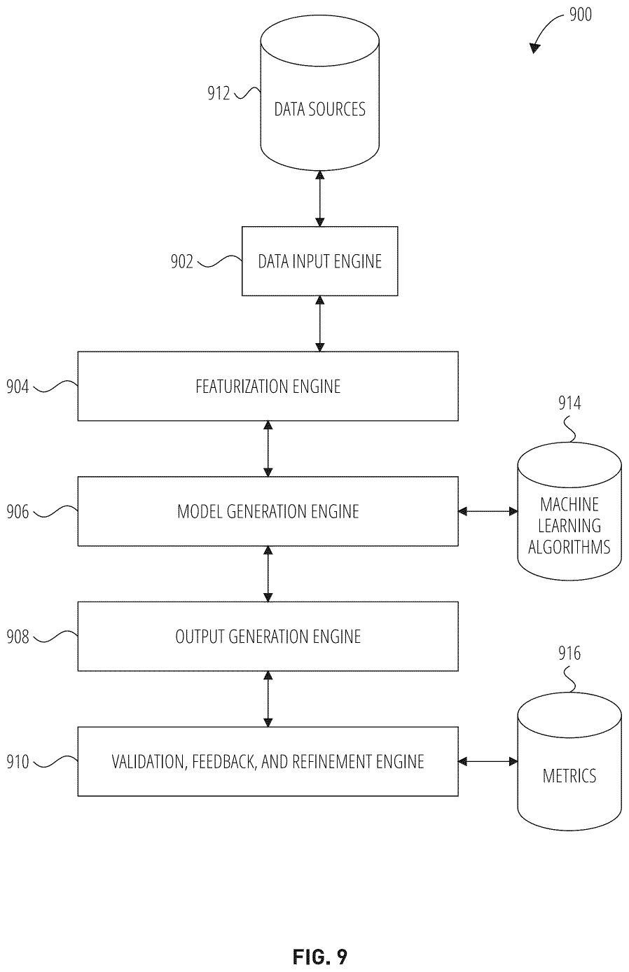

FIG. 9 illustrates a machine learning system 900, according to some examples. The machine learning system 900 may be used to implement aspects of the present disclosure. The machine learning system 900 is shown to include a data input engine 902, a featurization engine 904, a model generation engine 906, an output generation engine 908, and a validation, feedback, and refinement engine 910.

The data input engine 902 may be configured to access, interpret, request, format, re-format, or receive input data from data sources 912. Data sources 912 may include training data (e.g., data for training machine learning models), validation data (e.g., data for comparing model output with known results to evaluate performance), or reference data (e.g., data used to establish baselines or inform model creation). The data input engine 902 can interact with external data systems via input/output (I/O) devices, network interfaces, or storage elements to ensure input data is processed and stored in a suitable format for further operations.

The featurization engine 904 may be configured to transform input data into features that are optimized or useful for machine learning. The featurization engine 904 can handle feature extraction, scaling, or selection, enabling the machine learning system 900 to identify and process relevant data attributes for subsequent modeling. For example, features extracted from raw data may be annotated, labeled, or transformed into numerical representations suitable for machine learning algorithms 914. The featurization engine 904 can work iteratively with other components to refine features based on model requirements or outcomes.

The model generation engine 906 is responsible for creating, training, and configuring one or more machine learning models based on input data and selected features. The model generation engine 906 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 914 may include various algorithms, including supervised, unsupervised, or reinforcement learning approaches, such as decision trees, neural networks, Support Vector Machines (SVMs), or deep learning architectures such as transformers or CNNs. The model generation engine 906 may also support iterative model refinement and validation cycles, enabling adaptability to evolving data or performance criteria.

In some examples, the output generation engine 908 is responsible for model inference. The output generation engine 908 processes data to produce predictions, classifications, or other results. The output generation engine 908 can also apply post-processing techniques such as aggregation, thresholding, or confidence scoring to ensure outputs are in a format suitable for downstream systems or user interpretation.

The validation, feedback, and refinement engine 910 may be configured to validate, monitor, or improve the performance and relevance of machine learning models over time. The validation, feedback, and refinement engine 910 can apply validation data to assess model outputs and integrates feedback from users or automated systems to improve models. Metrics 916 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 900 may be implemented by hardware processors and may communicate via network interfaces or shared storage elements to facilitate data exchange and coordination. The architecture shown in FIG. 9 allows for flexible deployment across various machine learning applications, such as natural language processing, computer vision, or predictive analytics.

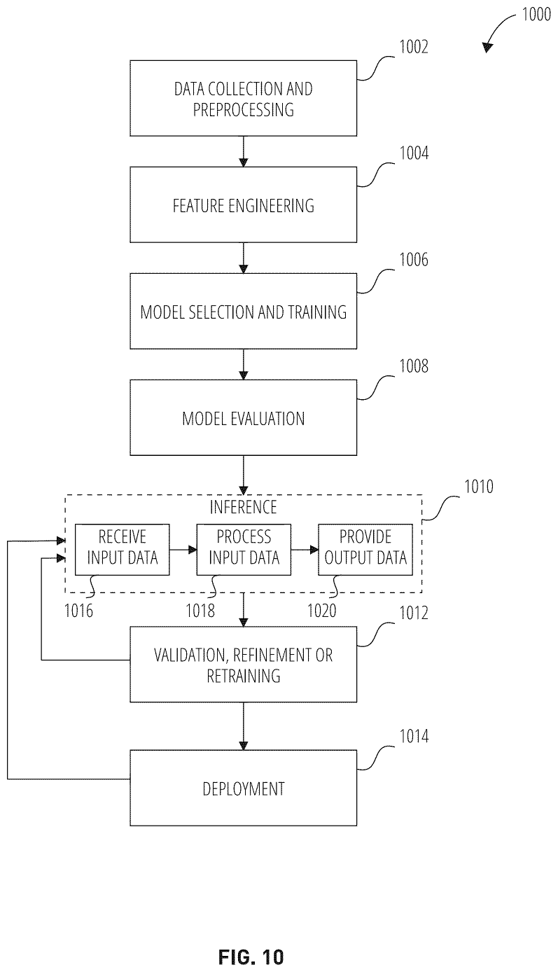

FIG. 10 is a flowchart depicting a machine learning pipeline 1000, according to some examples. The machine learning pipeline 1000, or parts thereof, may be used to generate a trained machine learning model for use in examples of the present disclosure.

The machine learning pipeline 1000 commences with a data collection and preprocessing stage 1002, in which data is acquired, cleaned, or formatted for compatibility with machine learning algorithms. The data collection and preprocessing stage 1002 may also involve addressing issues such as duplicate entries, missing values, or data inconsistencies.

During a feature engineering stage 1004, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be a variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 1006 can include selecting an appropriate machine learning algorithm or strategy and training the relevant model on training data. The model selection and training stage 1006 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from 32-bit floating-point to 8-bit integers), enabling efficient deployment on hardware-constrained environments such as edge devices. Pruning removes redundant or non-contributory connections within a model, thereby reducing memory and processing requirements. Knowledge distillation transfers the learned knowledge of a large, complex model into a smaller, lightweight model.

A model evaluation stage 1008 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 10 further shows an inference stage 1010, in which a trained model generates outputs on new, unseen data. For example, for each input, at operation 1016, the model receives input data (e.g., from external sources, such as real-time sensors, databases, or user-provided queries, or internal sources such as test inputs). At operation 1018, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 1020.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 1000 may also include a validation, refinement, or retraining stage 1012. This may include updating a model based on feedback generated from the inference stage 1010, such as new data or user feedback. In some examples, validation is performed using a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 1014, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some examples, the generated content may be similar to original data, but not identical.

Some of the techniques or architectures that may be used in generative AI are GANs, Variational autoencoders (VAEs), and transformers. GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some examples, transformer models can handle sequential data, such as text or speech, as well as non-sequential data, such as images or code.

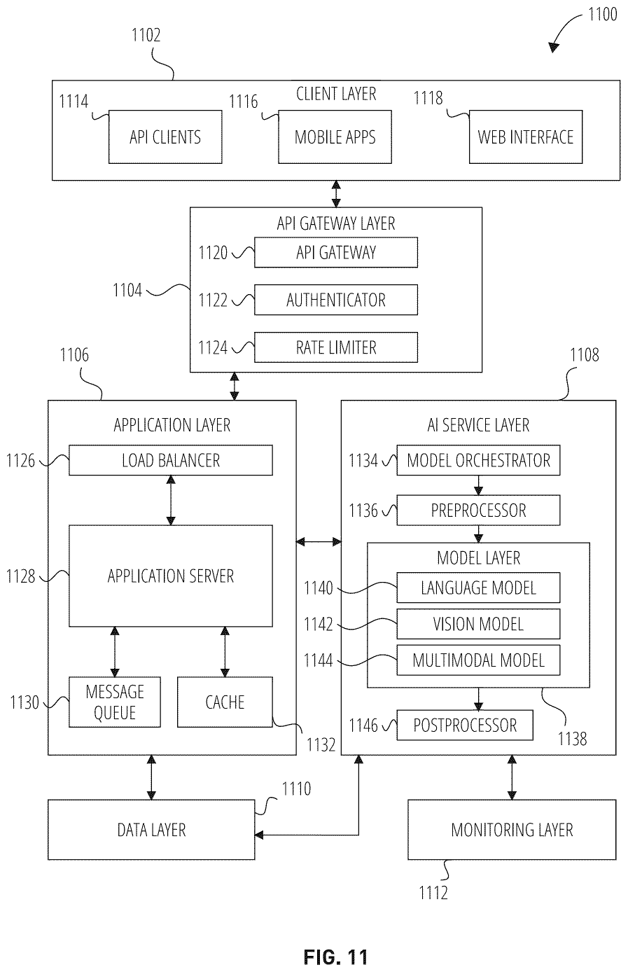

FIG. 11 is a system architecture diagram showing a layered view of an AI integrated system 1100, according to some examples. The AI integrated system 1100 comprises six example layers: a client layer 1102, an API gateway layer 1104, an application layer 1106, an AI service layer 1108, a data layer 1110, and a monitoring layer 1112.

The client layer 1102 provides multiple access points for system interaction. It includes API clients 1114, which may enable programmatic access to the capabilities of the AI integrated system 1100 or integration with third-party systems and services. Mobile applications 1116 facilitate access from mobile applications and devices, for example implementing native mobile protocols while maintaining consistent communication patterns with backend systems. A web interface 1118 enables browser-based access to the capabilities of the AI integrated system 1100 and may communicate with other layers using, for example, Hypertext Transfer Protocol (HTTP) or Hypertext Transfer Protocol Secure (HTTPS) protocols.

The API gateway layer 1104 serves as an entry point for client communications. The API gateway layer 1104 comprises an API gateway 1120, which may implement routing logic to direct incoming requests to appropriate backend services. An authenticator 1122 validates client credentials, for example using industry-standard protocols, such as OAuth 2.0 (Open Authorization 2.0) or JWT (JSON Web Tokens). In some examples, a rate limiter 1124 of the API gateway layer 1104 operates to prevent system abuse or ensure resource allocation among clients.

The application layer 1106 comprises various processing capabilities. In some examples, the application layer 1106 includes a load balancer 1126 that may distribute incoming requests across multiple application server instances to support resource utilization and system reliability. An application server 1128 may implement business or core functional logic of the AI integrated system 1100, processing requests and coordinating responses across various system components. In some examples, a message queue 1130 facilitates asynchronous processing capabilities, enabling efficient handling of operations, and a cache 1132 operates within the application layer 1106 to improve response times for frequently requested data.

The AI service layer 1108 provides AI capabilities through a structured approach to model deployment and execution. In some examples, the AI service layer 1108 includes a model orchestrator 1134 that coordinates the execution of one or various AI models, managing resource allocation and implementing routing logic to direct requests to appropriate model instances. A preprocessor 1136 may prepare input data for model consumption, implementing transformations, validations, or other preprocessing operations.

FIG. 11 shows the AI service layer 1108 as including a model layer 1138. The model layer 1138 may include multiple model types, including, for example, one or more of: a language model 1140 for processing textual input, implementing natural language processing capabilities; a vision model 1142 for handling image or video processing tasks; and a multimodal model 1144 that combines multiple input types to provide comprehensive analysis capabilities. In some examples, a vision model 1142 implements temporal feature scaling as described in the present disclosure. In some examples, a postprocessor 1146 of the AI service layer 1108 transforms model outputs into standardized formats suitable for client consumption. The data layer 1110 provides persistent storage capabilities.

While not detailed in FIG. 11, it is noted that the data layer 1110 may include various components such as a primary database for maintaining transactional data, a vector database for optimizing storage and retrieval of high-dimensional vectors used in AI applications and models of the AI service layer 1108, or a file storage component for managing binary data assets.

The monitoring layer 1112 may provide observability capabilities across the AI integrated system 1100. This may include logging for capturing system events, metrics collection for performance analysis, or distributed tracing for detailed analysis of request flow through the system.

Communication between layers of the AI integrated system 1100 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 2 (HTTP/2), gRPC (Google Remote Procedure Call), or proprietary protocols where appropriate.

Referring again to the model layer 1138, this layer may incorporate various types of machine learning models. Neural networks may be deployed to implement various architectures suited to specific processing needs.

A language model such as the language model 1140 may use transformer-based architectures (e.g., Bidirectional Encoder Representations from Transformers (BERT), Generative Pre-trained Transformer (GPT) variants, or Text-to-Text Transfer Transformer (T5)) for processing textual data and implementing natural language understanding capabilities. A vision model such as the vision model 1142 may employ specialized neural network architectures (e.g., CNNs, Vision Transformers (ViT), or Residual Neural Network (ResNet) variants) for processing visual information and extracting features from images or video streams. A multimodal model such as the multimodal model 1144 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities.

The AI service layer 1108 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 1108 to handle uncertainty in decision-making processes, working in conjunction with the preprocessor 1136 and postprocessor 1146 components to provide probability estimates and confidence metrics for model outputs.

Each model type may be implemented using various deployment strategies, with the model orchestrator 1134 managing their execution and resource allocation to ensure adequate performance and efficient system operation. This may include coordinating the deployment and execution of various model types, ensuring efficient resource allocation, and appropriate model selection based on specific task requirements. While in some examples the model layer 1138 provides server-based access to one or more models, a model can alternatively (or additionally) be deployed so as to perform inference locally (e.g., at the client layer 1102).

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method for processing a temporal sequence of input frames through a neural network, the method performed by at least one processor and comprising: accessing feature maps of a current input frame in the temporal sequence; scaling the feature maps of the current input frame using excitation values generated from a previous input frame in the temporal sequence; and generating, from the current input frame, new excitation values to perform scaling for a subsequent input frame in the temporal sequence.

In Example 2, the subject matter of Example 1 includes, scaling the feature maps of the current input frame using the excitation values generated from the previous input frame while generating the new excitation values from the current input frame.

In Example 3, the subject matter of any of Example 1 includes, commencing scaling of the feature maps of the current input frame using the excitation values generated from the previous input frame before any of the new excitation values are generated from the current input frame.

In Example 4, the subject matter of any of Examples 1-3 includes, processing the feature maps in a line-by-line manner, e.g., commencing scaling of the feature maps of the current input frame using the excitation values generated from the previous input frame in a line-by-line manner before completion of the generating of the new excitation values.

In Example 5, the subject matter of any of Examples 1-4 includes, wherein: accessing of the feature maps of the current input frame comprises receiving input feature map lines associated with the current input frame sequentially; and scaling of the feature maps comprises generating output feature map lines by applying the excitation values generated from the previous input frame to the input feature map lines sequentially and while receiving the input feature map lines, such that at least one of the output feature map lines is generated before all of the input feature map lines are received.

In Example 6, the subject matter of any of Examples 1-5 includes, wherein the neural network comprises an SE mechanism, the SE mechanism comprising at least one SE block to process output from one or more convolution layers in the neural network, each of the at least one SE block comprising a squeeze component, an excitation component, and a scaling component.

In Example 7, the subject matter of Example 6 includes, wherein generating the new excitation values comprises: processing the feature maps of the current input frame using global average pooling via the squeeze component to obtain pooled data; and processing the pooled data via the excitation component to obtain the new excitation values.

In Example 8, the subject matter of any of Examples 1-7 includes, wherein the neural network comprises an SE mechanism, and the neural network comprises at least two SE blocks arranged in cascade.

In Example 9, the subject matter of Example 8 includes, wherein each subsequent SE block in the at least two SE blocks uses excitation coefficients from progressively earlier input frames in the temporal sequence for scaling operations associated with the current input frame.

In Example 10, the subject matter of any of Examples 1-9 includes, wherein the previous input frame is an immediately preceding frame in the temporal sequence, relative to the current input frame.

In Example 11, the subject matter of any of Examples 1-10 includes, wherein the previous input frame is a frame prior to an immediately preceding frame in the temporal sequence, relative to the current input frame.

In Example 12, the subject matter of any of Examples 1-11 includes, wherein the at least one processor comprises an event-based neural processor.

In Example 13, the subject matter of any of Examples 1-12 includes, wherein the method is performed by the at least one processor in an XR device.

In Example 14, the subject matter of any of Examples 1-13 includes, wherein the neural network is a neural network of a computer vision model.

In Example 15, the subject matter of Example 14 includes, wherein the input frames comprise video frames, the method further comprising: generating an object pose estimation for an object depicted in the video frames based on a result of processing of the video frames by the computer vision model.

Example 16 is a system comprising: at least one processor; and at least one memory storing instructions that, when executed by the at least one processor, configure the system to perform operations for processing a temporal sequence of input frames through a neural network, the operations comprising: accessing feature maps of a current input frame in the temporal sequence; scaling the feature maps of the current input frame using excitation values generated from a previous input frame in the temporal sequence; and generating, from the current input frame, new excitation values to perform scaling for a subsequent input frame in the temporal sequence.

In Example 17, the subject matter of Example 16 includes, wherein the at least one processor comprises an event-based neural processor.

In Example 18, the subject matter of Example 17 includes, wherein the event-based neural processor comprises a plurality of processing clusters.

Example 19 is an extended reality (XR) device comprising: the system of Example 16; and at least one image sensor to capture the temporal sequence of input frames.

Example 20 is one or more non-transitory machine-readable storage media including instructions that, when executed by one or more processors, cause the one or more processors to perform operations for processing a temporal sequence of input frames through a neural network, the operations comprising: accessing feature maps of a current input frame in the temporal sequence; scaling the feature maps of the current input frame using excitation values generated from a previous input frame in the temporal sequence; and generating, from the current input frame, new excitation values to perform scaling for a subsequent input frame in the temporal sequence.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Although specific examples are described herein, it will be evident that various modifications and changes may be made to these examples without departing from the broader spirit or scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” or merely for convenience and without intending to voluntarily limit the scope of this application to any single example or concept if more than one is in fact disclosed. Thus, although specific examples have been illustrated and described herein, it should be appreciated that another arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations. Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Any biometric or other personally identifiable information (PII) collected by biometric or other data capturing components is captured and stored only with user approval and deleted on user request. Further, such data may be used for very limited purposes, such as identification verification. To ensure limited and authorized use of biometric and other PII, access to this data is restricted to authorized personnel only, if at all. The data is not shared or sold to any third party without the explicit consent of the user. In addition, appropriate technical and organizational measures are implemented to ensure the security and confidentiality of this sensitive information.

As used herein, a “component” may include a device, physical entity, or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor, a group of processors or part of a processor) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components.

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors (or part thereof) being an example of hardware. For example, at least some of the operations of a method may be performed by one or more processors or processor-implemented components.

At least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

As used herein, a “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a CPU, a Reduced Instruction Set Computing (RISC) Processor, a Complex Instruction Set Computing (CISC) Processor, a GPU, a Digital Signal Processor (DSP), a Tensor Processing Unit (TPU), an NPU such as an event-based neural processor, a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware. Accordingly, unless a specific processor architecture, hardware, design, and/or structure is specified or is clear from the context, the term “processor,” “processing system,” or the like, should be interpreted broadly herein.

As used herein, a “computer-readable storage medium” may include both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

As used herein, a “machine storage medium” may include a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium.”

As used herein, a “non-transitory computer-readable storage medium” may include a tangible medium that is capable of storing, encoding, or carrying the instructions for execution by a machine, while a “signal medium” may include any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

What is claimed is:

1. A method for processing a temporal sequence of input frames through a neural network, the method performed by at least one processor and comprising:
accessing feature maps of a current input frame in the temporal sequence;
scaling the feature maps of the current input frame using excitation values generated from a previous input frame in the temporal sequence; and
generating, from the current input frame, new excitation values to perform scaling for a subsequent input frame in the temporal sequence.

2. The method of claim 1, comprising scaling the feature maps of the current input frame using the excitation values generated from the previous input frame while generating the new excitation values from the current input frame.

3. The method of claim 1, comprising commencing scaling of the feature maps of the current input frame using the excitation values generated from the previous input frame before any of the new excitation values are generated from the current input frame.

4. The method of claim 1, comprising commencing scaling of the feature maps of the current input frame using the excitation values generated from the previous input frame in a line-by-line manner before completion of the generating of the new excitation values.

5. The method of claim 1, wherein:
accessing of the feature maps of the current input frame comprises receiving input feature map lines associated with the current input frame sequentially; and
scaling of the feature maps comprises generating output feature map lines by applying the excitation values generated from the previous input frame to the input feature map lines sequentially and while receiving the input feature map lines, such that at least one of the output feature map lines is generated before all of the input feature map lines are received.

6. The method of claim 1, wherein the neural network comprises a squeeze-and-excitation (SE) mechanism, the SE mechanism comprising at least one SE block to process output from one or more convolution layers in the neural network, each of the at least one SE block comprising a squeeze component, an excitation component, and a scaling component.

7. The method of claim 6, wherein generating the new excitation values comprises:
processing the feature maps of the current input frame using global average pooling via the squeeze component to obtain pooled data; and
processing the pooled data via the excitation component to obtain the new excitation values.

8. The method of claim 1, wherein the neural network comprises an SE mechanism, and the neural network comprises at least two SE blocks arranged in cascade.

9. The method of claim 8, wherein each subsequent SE block in the at least two SE blocks uses excitation coefficients from progressively earlier input frames in the temporal sequence for scaling operations associated with the current input frame.

10. The method of claim 1, wherein the previous input frame is an immediately preceding frame in the temporal sequence, relative to the current input frame.

11. The method of claim 1, wherein the previous input frame is a frame prior to an immediately preceding frame in the temporal sequence, relative to the current input frame.

12. The method of claim 1, wherein the at least one processor comprises an event-based neural processor.

13. The method of claim 1, wherein the method is performed by the at least one processor in an extended reality (XR) device.

14. The method of claim 1, wherein the neural network is a neural network of a computer vision model.

15. The method of claim 14, wherein the input frames comprise video frames, the method further comprising:
generating an object pose estimation for an object depicted in the video frames based on a result of processing of the video frames by the computer vision model.

16. A system comprising:
at least one processor; and
at least one memory storing instructions that, when executed by the at least one processor, configure the system to perform operations for processing a temporal sequence of input frames through a neural network, the operations comprising:
accessing feature maps of a current input frame in the temporal sequence;
scaling the feature maps of the current input frame using excitation values generated from a previous input frame in the temporal sequence; and
generating, from the current input frame, new excitation values to perform scaling for a subsequent input frame in the temporal sequence.

17. The system of claim 16, wherein the at least one processor comprises an event-based neural processor.

18. The system of claim 17, wherein the event-based neural processor comprises a plurality of processing clusters.

19. An extended reality (XR) device comprising:
the system of claim 16; and
at least one image sensor to capture the temporal sequence of input frames.

20. One or more non-transitory machine-readable storage media including instructions that, when executed by one or more processors, cause the one or more processors to perform operations for processing a temporal sequence of input frames through a neural network, the operations comprising:
accessing feature maps of a current input frame in the temporal sequence;
scaling the feature maps of the current input frame using excitation values generated from a previous input frame in the temporal sequence; and
generating, from the current input frame, new excitation values to perform scaling for a subsequent input frame in the temporal sequence.
